(19) United States
(12) Patent Application Publication
(10) Pub. No.: US 2004/0072467 A1
(43) Pub. Date: Apr. 15, 2004

(54) Flexible electrical connector, connection arrangement including a flexible electrical connector, a connector receiver for receiving a flexible electrical connector

(76) Inventors: Nicholas Jordan, Bristol (GB); Arthur Cheumin Woo, Bristol (GB); Andrew Riden, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/633,598

(22) Filed: Aug. 5, 2003

(30) Foreign Application Priority Data
Aug. 6, 2002 (GB) 0218187.3

(51) Int. Cl. H01R 12/24

(52) U.S. Cl. 439/492

(57) ABSTRACT

A flexible electrical connector adapted to connect to a complimentary electrical connector receiver, said flexible electrical connector comprises first and second pluralities of a spaced apart, elongate, signal carriers; an elongate current return conductor; and an insulator. The first plurality of signal carriers are spaced apart from the current return conductor by the insulator and extend substantially parallel to the current return conductor. The second plurality of signal carriers are spaced from an opposite side of the current return conductor to the first plurality of signal carriers by a further insulator. Respective exposed end regions of the first and second pluralities of signal carriers and the current return conductor comprise respective, integrally formed contact regions thereof. The contact regions are adapted to couple the first and second pluralities of signal carriers and the current return conductor electrically to corresponding contacts of the complimentary electrical connector receiver.

### FIELD OF THE INVENTION

This invention relates to a flexible electrical connector, connection arrangement including a flexible electrical connector, a connector receiver for receiving a flexible electrical connector. More particularly, but not exclusively, it relates to a low insertion force flexible electrical connector.

### RELATED BACKGROUND ART

A typical flexible electrical connector (100), as shown in FIG. 1, comprises a plurality of signal carrying tracks (102) mounted upon a flexible insulator base (104) and terminates in a connector head (106). The head includes a plurality of pins (108) that typically contact the tracks (102) by being soldered thereto. The pins (108) are received, in use, by complimentary recesses in a mounting head, not show. This arrangement is difficult to manufacture, as it requires the accurate soldering of pins (108) to tracks (102). This has an associated cost, complexity, and time in the manufacturing process.

Additionally, in order to achieve positive location of the connector head (106) and the mounting head it is necessary to apply a large insertion force in order to overcome male-female mating forces. This large insertion force can result in bending or breaking of pins (108) if a slight misalignment occurs between the connector head (106) and the mounting head, thus reducing the number of channels available for signal transmission.

A further difficulty associated with current flexible connector arrangements is a limit upon the number of signals that can be carried by a connector. This limitation is particularly acute for alternating current signals.

Referring now to FIG. 2a, a prior art flexible connector (200) comprising a plurality of signal tracks (202a-f) mounted upon a flexible insulator (204), the connector head has been omitted for clarity.

As alternating current always flows in a loop there must be a current return path for returning current to a driving element in order to close the loop. The current return path is usually a ground conductor held at 0V. It is usual to have alternate tracks acting as respective signal carriers (202a,c,e) and current return paths (202b,d,f). Thus, the signal carrying density of the connector is based upon only half of the number of tracks upon the connector. An alternative arrangement has been used in the prior art in which a single track acts as a current return path for multiple signals carrying tracks. This arrangement has a significant amount of crosstalk due to magnetic and capacitive coupling and common path noise, as are detailed hereinafter.

As current flowing in a loop produces an electromagnetic (E/M) field around it, which is predominantly magnetic. These fields can overlap and produce inductive and capacitive coupling between signals on adjacent tracks.

FIG. 2b, shows another prior art electrical connector (210) comprising a plurality of signal carrying tracks (212a-f) mounted upon a flexible insulator (214). The insulator (214) has a conducting ground plane (216) held within it, again the connector head is omitted for clarity. The ground plane (216) acts as a common current return path for all of the signal carrying tracks (212a-f). This has a number of advantages over the arrangement of FIG. 2a including minimising the loop area formed by the signal and its return current with a consequential reduction in differential mode radio-frequency interference (RFI) and E/M interference (EMI) radiated from the connector. The smaller loop area reduces pickup of E/M fields radiated externally of the connector thereby increasing E/M compatibility (EMC) and signal integrity.

As the current loops are no longer coplanar the use of the ground plane reduces coupling due to mutual inductance. Capacitive crosstalk amplitude is also reduced due to lower impedance of the signal tracks due to the ground plane.

The use of a ground plane to minimise EMI/RFI and crosstalk is known, see for example U.S. Pat. Nos. 5,839,916, 5,552,565 and 5,658,164. Such arrangements typically rely on one, or a few, pins (similar to pins 108) to contact to the ground plane to a PCB and provide the current return path. This leads to increased impedance at the contacts, which results in the slowing of rise times of edges of high speed signals (e.g. signals with a rise time of less than 5 ns). This is due to the parasitic capacitance and inductance, which are due to the arrangements of conventional connections, where discrete pins are dedicated either to signals or to ground.

### SUMMARY OF THE INVENTION

According to a first aspect of the present invention there is provided a flexible electrical connector adapted to connect to a complimentary electrical connector receiver, said flexible electrical connector comprising a first plurality of a spaced apart, elongate, signal carriers; an elongate current return conductor; and an insulator; said signal carriers being spaced apart from said current return conductor by said insulator and extending substantially parallel to said current return conductor, respective exposed end regions of said plurality of signal carriers and said current return conductor comprising respective, integrally formed contact regions thereof, said contact regions being adapted to couple said signal carriers and said current return conductor electrically to corresponding contacts of said complimentary electrical connector receiver.

Integrally formed contact regions remove the necessity to solder connector head pins to electrical tracks, thereby simplifying the construction of the flexible connector. The use of a single current return conductor, typically a planar sheet or mesh, for example a ground plane, increases the number of tracks that are available to carry signals as it is necessary to have pairs of tracks, with one of the pair being used as a current return path.

By not having a process step of attaching specific contact coupling formations to said signal carriers (e.g. tracks) and/or said return current conductor (e.g. ground plane) we may reduce manufacturing cost and time. Having the end regions of the tracks/ground plane be their own contact formations, and designing the complimentary electrical connector receiver to bear on exposed surfaces of the tracks and/or ground plane is a simplification in comparison to prior art.

There may be provided a second plurality of elongate spaced apart signal carriers spaced from an opposite side of the current return conductor by an insulator and having an exposed end region defining an integrally formed contact region thereof.

The current return conductor is typically planar, for example a sheet of metal (e.g. copper), or a mesh. It will commonly be a ground plane. The current return conductor may be wider than a single signal carrier. Preferably the current return conductor is at least as wide as a total width spanned by the plurality of signal carriers. Where there are two pluralities of signal carriers the current return conductor may be at least as wide as a total width spanned by a wider one of either of the plurality of signal carriers. This allows the current return conductor to act as a return current path for more than one, and preferably all, of the signal carriers. This may reduce RFI and EMI cross-talk effects in both pluralities of signal carriers.

The current return conductor and the plurality of signal carriers may be non-coterminous. The current return conductor may extend longitudinally of said connector beyond a terminal end of the plurality of signal carriers. In the case where there is a second plurality of signal carriers the second plurality of signal carriers may extend longitudinally of said connector beyond a terminal end of the plurality of signal carrier and may extend longitudinally beyond a terminal end of the current return conductor. Preferably the respective exposed regions of the first plurality of signal carriers and the current return conductor are disposed at different longitudinal positions along the length of the connector. This allows spatial clearance between points of contact associated with each of the signal carriers and the current return conductor, thus making positive contact to the respective current paths more likely.

The connector may have a positive location formation disposed at an edge or side portion thereof. The positive location formation may comprise a tab or notch arranged to co-operate with a complimentary fixture of a device. The positive location formation may comprise a tab projecting from a side portion. This allows the connector to be positively located in relation to a device, for example a printed circuit board (PCB), and can ensure that the connector is oriented correctly. The positive location formation may also comprise connector-orientation means, or alternatively, or additionally, a separate orientation formation may be provided. If the signal carriers and the current return conductor are staggered the provision of orientation and/or positive location formation may ensure that the correct connections are made, which can be helpful.

The signal carriers may be tracks, typically copper, which may be thin films deposited upon the insulators. This reduces the overall thickness of the connector.

The current return conductor may be a sheet of conducting material, typically a metal such as copper. Alternatively, the current return conductor may be a mesh of a conducting material, typically a metal such as copper. The use of sheets or meshes give a high degree of flexibility in both longitudinal and transverse directions.

The connector may be a flexible flat connector (FFC) or it may be a flexible printed circuit (FPC). The connector may be arranged to connect an output port of a device to an input port of the same or a different device. Thus, the connector can be used internally of a single device, for example connecting sections of printed circuit board (PCB), or it can be used to connect two separate devices, for example connecting two PCBs. Preferably the connector is used to join two points on a PCB, or two other points which have a fixed, non-moveable, relationship with each other. Thus the flexible connector does not typically experience significant forces at its junctions with devices to which it connects.

According to a second aspect of the present invention there is provided a connection arrangement comprising a flexible connector in accordance with the first aspect of the present invention and a complimentary electrical connector receiver comprising a housing, a first plurality of signal contacts and a current, return conductor contact; each of said first plurality of signal contacts being configured so as to allow said connector to pass thereover so as to enable said current return conductor contact said current return conductor contact.

The current return conductor contact being may be arranged to contact said current return conductor contact region over a substantial fraction of said current return conductor's width, in use, when said first plurality of signal carrier contact regions are in contact with said first plurality of signal contacts.

This arrangement allows a low force insertion of the connector into the connector receiver as it is only necessary to overcome frictional forces between the connector and the receiver: there is no need to push a male connector through a restricted aperture as require by male-female prior art arrangements. When the connector is positively inserted into the housing a connection between the signal carriers and their respective contacts may occur substantially simultaneously.

There may be a single elongate contact for. contacting the current return conductor to ground over an area of contact. This typically results in a lower inductance connection than a point contact to the current return conductor. This reduces RFI, EMC and the slowing of signal edges. The housing may have a second plurality of signal contacts, which are arranged to contact a second plurality of signal carrier contact regions, in use. The plurality of signal contacts may be arranged to be biased against the connector at a first surface and the second plurality of signal contacts may be arranged to be biased against the connector at the second surface so as to retain positively, in use, the connector. The signal contacts and the current return conductor may be arranged to be biased against a surface of the connector, in use. This arrangement retains the connector with the housing with increased force, thereby increasing the confidence in the signal connections established between the signal carrying means and the signal contact means.

The housing may comprise a fixing arranged to co-operate with a male or female location formation upon the connector, in use.

The current return conductor contact of a complimentary electrical receiver may have contact-point augmentation means, for example it may be roughened, rippled, bent or dimpled, or may have projections thereupon, or the like. This serves to provide an increased number of points of contact, and an increased surface area of actual contact between the current return conductor contact and the current return conductor than if the contact were smooth and planar or finger like, thereby reducing inductance associated with the contact.

According to a third aspect of the present invention there is provided a method of reducing inductance in an electrical connection, including a flexible electrical connector, suitable for carrying high frequency signals comprising the steps of:

(i) providing a current return conductor and a signal carrier spaced apart by an insulator;

(ii) contacting an elongate ground connector to the current return conductor over substantial part of a width of the current return conductor so as to provide an extended contact region therebetween.

According to a fourth aspect of the present invention there is provided a reduced inductance electrical connection arrangement suitable for carrying high frequency signals, comprising a flexible electrical connector having a current return conductor and a signal carrier spaced apart by an insulator, and an elongate ground connector, the ground connector being arranged to contact the current return conductor over a substantial part of a width thereof.

According to a fifth aspect of the present invention there is provided a method of increasing signal carrying capacity of a flexible electrical connector comprising the steps of:

(i) providing a conducting current return conductor;

(ii) providing first and second signal carriers; and

(iii) spacing said first and second signal carriers from opposite faces of the current return conductor by an insulator.

This method provides a flexible connector with signal carriers on either side of the current return conductor. This increases the number of channels available to carry signals over the prior art arrangements.

There may be provided first and second pluralities of signal carriers spaced apart from opposite faces of the current return conductor by an insulator.

According to a sixth aspect of the present invention there is provided a connector receiver for receiving a flexible connector, comprising a housing, a current return conductor contact, and a signal contact; the current return conductor contact being arranged to contact a current return conductor of the flexible connector over a substantial fraction of said current return conductor's width, and the signal contact being arranged to a contact signal carrier of the flexible connector, in use.

There may be provided at least one further signal contact arranged to contact at least one further signal carrier. Said further signal carrier may be disposed upon an opposite face of the flexible connector from the signal carrier.

The current return conductor contact and the signal contact may be spaced apart longitudinally with respect to the flexible connector. They may be spaced apart with respect to the direction of insertion of the flexible connector to the connector receiver.

According to a seventh aspect of the present invention there is provided a connection arrangement comprising a connector in accordance with the sixth aspect of the present invention and a connector receiver comprising a housing, a plurality of signal contact means, and ground plane contact means; each of said plurality signal contact means being configured so as to allow the connector to pass thereover to enable said ground plane means to contact said ground plane contact means said ground plane means, and said ground plane contact means making electrical contact over a substantial fraction of said ground plane means' width, in use, when said plurality of signal carrying means are in contact with said plurality of signal contact means.

According to an eighth aspect of the present invention there is provided a connector receiver for receiving a flexible connector comprising a housing, ground plane contact means, and signal contact means; said ground plane contact means being arranged to contact ground plane means of said flexible connector over a substantial fraction of said ground plane's width, and said signal contact means being arranged to contact signal carrying means of the flexible connector, in use.

According to a ninth aspect of the present invention there is provided a flexible electrical connector for carrying signals in accordance with the first aspect of the present invention wherein a terminal end of the plurality of signal carriers is longitudinally displaced relative to a terminal end of the other of the ground plane.

According to a tenth aspect of the present invention there is provided a flexible electrical connector for carrying signals in accordance with the first aspect of the present invention wherein the plurality of signal carriers substantially overlie the ground plane.

According to an eleventh aspect of the present invention there is provided a method of manufacturing an electronic device comprising the steps of:

i) providing a flexible electrical connector having an exposed end region of at least one of a signal carrier or a current return conductor operable to serve as an integrally formed contact; and

ii) forming an electrical contact between said at least one exposed end region and a complimentary connector of said electronic device.

According to a twelfth aspect of the present invention there is provided a flexible electrical connector adapted to connect to a complementary electrical connector receiver, said flexible electrical connector comprising first and second pluralities of spaced apart, elongate, metallic tracks; an elongate metallic ground plane; and an insulator; said first and second pluralities of tracks being spaced apart from opposite surfaces of said ground plane by said insulator and extending substantially parallel to said ground plane, respective exposed end regions of said first and second pluralities of signal carriers and said ground plane comprising respective, integrally formed, contact regions thereof, said contact regions being adapted to couple said first and second pluralities of tracks and said ground plane electrically to corresponding contacts of said complimentary electrical connector receiver.

According to a thirteenth aspect of the present invention there is provided a flexible electrical connector adapted to connect to a complimentary electrical connector receiver, said flexible electrical connector comprising first and second pluralities of spaced apart, elongate, thin film metal tracks, each of which is arranged to carry a signal; an elongate metal ground plane; and an insulating layer; said first plurality of metal tracks being spaced apart from said ground plane by said insulating layer and extending substantially parallel to said ground plane, and said second plurality of metal tracks being spaced from an opposite side of said ground plane to said first plurality of metal tracks by an, or the, insulating layer, respective exposed end regions of said first and second pluralities of metal tracks and said ground plane comprising respective, integrally formed contact regions thereof, said contact regions being adapted to couple said first and second pluralities of metal tracks and said ground plane electrically to corresponding contacts of said complimentary electrical connector receiver.

According to a fourteenth aspect of the present invention there is provided a connection arrangement comprising a flexible connector comprising a flexible electrical connector adapted to connect to a complimentary electrical connector receiver, said flexible electrical connector comprising first and second pluralities of spaced apart, elongate, thin film metal tracks, each of which is arranged to carry a signal; an elongate metal ground plane; and an insulating layer; said first plurality of metal tracks being spaced apart from said ground plane by said insulating layer and extending substantially parallel to said ground plane, and said second plurality of metal tracks being spaced from an opposite side of said ground plane to said first plurality of metal tracks by an, or the, insulating layer, respective exposed end regions of said first and second pluralities of metal tracks and said ground plane comprising respective, integrally formed contact regions thereof, said contact regions being adapted to couple said first and second pluralities of metal tracks and said ground plane electrically to corresponding contacts of said complimentary electrical connector receiver and a complimentary electrical connector receiver comprising a housing, first and second pluralities of signal contacts, and a ground plane contact: each of said first and second pluralities of signal contacts being arranged to engage said respective contact regions of said first and second pluralities metal tracks, each of said first plurality of signal contacts being configured so as to allow said connector to pass thereover so as to enable said ground plane to contact said ground plane contact.

According to a fifteenth aspect of the present invention there is provided a connector receiver for receiving a flexible connector, comprising a housing, a ground plane contact, and first and second signal contacts, said ground plane contact being arranged to contact a metal ground plane of said flexible connector over a substantial fraction of said ground plane's width, and said first signal contact being arranged to contact a first metal track, arranged to carry a signal, of said flexible connector, and said second signal contact being arranged to contact a second metal track, arranged to carry a signal, of said flexible connector, said second metal track being disposed upon an opposite face of said flexible connector from said signal carrier.

It will be appreciated that in any of the foregoing arrangements said ground plane contact means may contact said ground plane contact means over substantially the whole of, or the whole of, the width of said ground plane means, and/or of the width of said ground plane contact means.

### BREIF DESCRIPTION OF THE DRAWINGS

The invention will now be described, by way of example only, with reference to the accompanying drawings, of which:

FIG. 1 is a schematic representation of a flexible connector of the prior art;

FIG. 2a is a schematic representation of a further flexible connector of the prior art;

FIG. 2b is a schematic representation of a yet further flexible connector of the prior art;

FIG. 3 is a schematic representation of a flexible connector in accordance with at least an aspect of the present invention;

FIG. 3A is a partial sectional view of an end of the flexible connector of FIG. 3;

FIG. 3B is an end elevational view of an end of a further embodiment of a flexible connector in accordance with at least an aspect of the present invention;

FIG. 3C is a representation of a positive location arrangement for the connector of FIG. 3;

FIG. 4 is a schematic representation of a flexible connector and a connector receiver in accordance with at least an aspect of the present invention;

FIGS. 4A to 4F; are schematic representations of various embodiments of a ground plane contact of the connector receiver of FIG. 4;

FIG. 5 is a schematic representation of a second embodiment of a connector receiver in accordance with at least an aspect of the present invention;

FIG. 6 is a flow chart detailing an example of a method of reducing inductances in a high frequency electrical connection;

FIG. 7 is a flow chart detailing an example of a method of increasing signal carrying capacity in a flexible electrical connector;

FIG. 8 is an alternative embodiment of a flexible electrical connector in accordance with the present invention; and

FIG. 9 is a further alternative embodiment of a flexible electrical connector in accordance with the present invention.

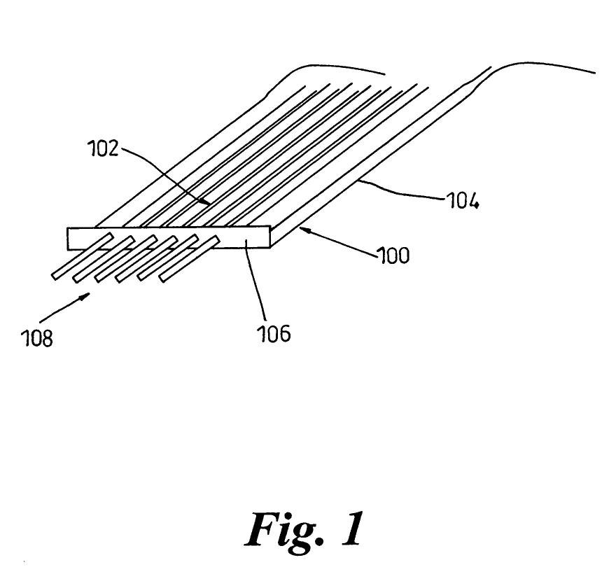

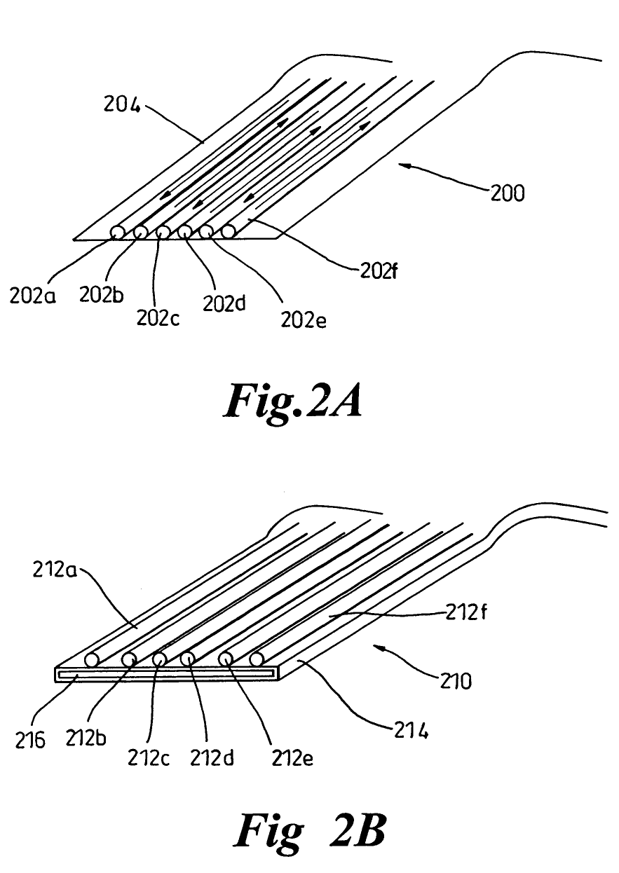

### DETAILED DESCRIPTION OF PREFERRED EMBODIMENTS

A flexible connector 300 according to the present invention comprises an elongate electrically conductive current return conductor, typically a ground plane 302, a first and second pluralities of generally parallel spaced apart signal carriers, usually metallic tracks 304, 306, and a insulator 308.

The ground plane 302 is typically a metal sheet or mesh, for example copper, and is enclosed within the insulator 308 over substantially all of its length. One surface of each end 310, (only one shown) or the ground plane 302 remains uncovered by the insulator 308 so as to provide ground contact regions 314 (only one shown). The connector also has laterally projecting tabs 317 at each end thereof, the tabs 317 having holes 318 therethrough.

The first plurality of signal tracks 304 typically, 5-10, 15 or 20 tracks (but there could be more, or less) are spaced apart from a first surface 319 of the ground plane 302 and are typically substantially encased within the insulator 308 with end regions 320, (only one shown) of the tracks 304 facing away from the ground plane 302 remaining free of insulator 308 so as to form signal contact regions 322, (only one shown).

The second plurality of signal tracks 306 extend beyond the contact region 332 of the first plurality of tracks 304 towards a terminal end of the connector and are spaced apart from a second surface 325 of the ground plane 302. The tracks 306 are substantially encased within the insulator 308. A free end 326 of the tracks 306 remain free from insulator so as to define a contact region 328.

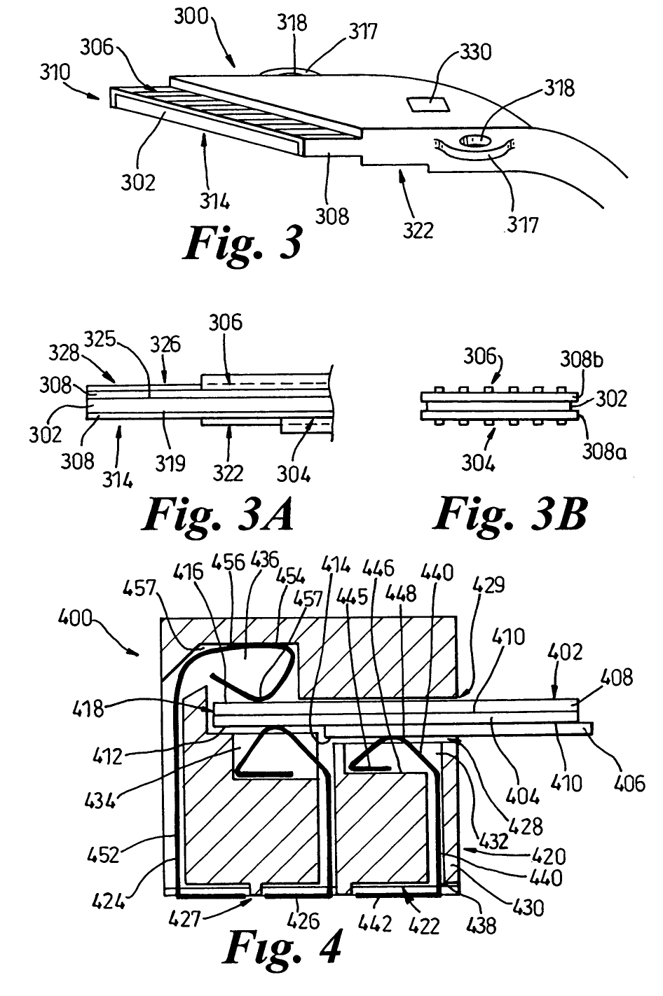

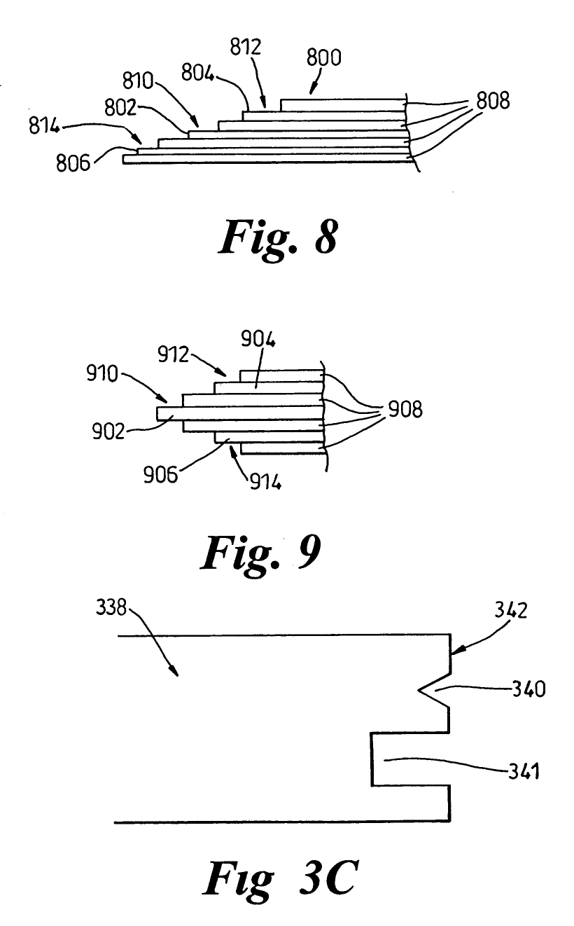

Although shown as a single insulator encasing the ground plane 302 and the signal tracks 304, 306 it will be appreciated that the insulator 308 can be two separate regions 308 of insulator respectively spacing the first and second plurality of tracks 304, 306 from the ground plane 302, and this is shown in FIG. 3A.

The flexible connector 300 includes a semiconductor device 330, typically a digital signal processor (DSP), into which a number of the signal tracks 304 pass. Signals carried by the tracks 304 are processed by the device 330 and the processed signals proceed along the tracks 304 to the signal contact region 324. Thus, the connector 300 constitutes a flexible printed circuit (FPC). It will be appreciated that should the connector 300 not include the semiconductor device 326 the connector 300 and signals pass directly along the tracks 304 the connector 300 will form a flexible flat conductor (FFC).

In use, a free end of the connector 300 is inserted into an output port of a device, the output port typically has centring means, such as guide edges to guide the end of the connector 300 thereinto. Contacts in the port marry with respective contact regions 322, of the first and second pluralities of signal tracks 304, 306. A further contact marrys with the contact region of the ground plane 302. Similar contacts are present in an input port of a device into which another similar free end of the connector is inserted. The holes 318 in the tabs 317 are arranged to receive a pin mounted on the device in order to ensure that the connector 300 is positively located. The holes 318 may have different sizes or cross sectional shapes, or positions, to ensure that the connector 300 can only be connected to the accepted part on one way (and not the other way up).

The nature and configuration of the contacts is described in detail hereinafter. It will be appreciated that the input and output ports may be part of the same device, for example linking circuit boards within a device, or they may be part of different devices, for example linking PC's.

Signals are passed along the connector 300 between the output port and the input port via the signal tracks 304, 306. Complementary ground return currents associated with signals carried by both the first and second pluralities of tracks 304, 306 pass from the input port to the output port along the ground plane 302. The mixing of signals in the ground plane is so extensive that it significantly reduces, or even substantially eliminates, cross-talk between adjacent and near adjacent signal tracks 304, 306.

Referring now to FIG. 3C in an alternative arrangement, a positive location formation of a connector 338 has a triangular recess 340 and a rectangular recess 341 extending into a free end 342 thereof that are arranged to receive complementarily shaped projections of a device. This aids in ensuring the correct insertions of the connector 338 into the device, as a rectangular projection will not be received by the triangular recess 340.

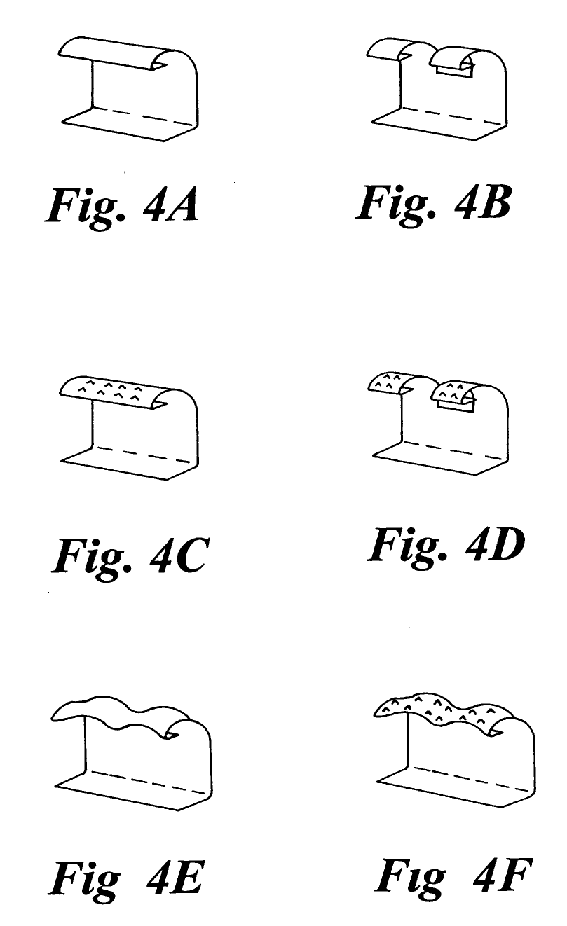

Referring now to FIG. 4, a connection arrangement 400, comprises a flexible connector 402 and a flexible connector receiver 404.

The flexible connector 402 comprises a ground plane 404, first and second pluralities of signal tracks 406, 408, and a insulator 410. The ground plane 404, and signal tracks 406, 408 are arranged so as to be substantially encapsulated within the insulator 410, as hereinbefore described with reference to FIG. 3, so as to define respective contact regions 412, 414, 416 at a free end 418 of each of them.

The receiver 404 comprises a housing 420, first and second pluralities of signal contacts 422, 424, having a pitch of approximately 1 mm, and a ground plane contact element 426.

The first and second plurality of signal contacts 422, 424 and the ground plane contact element 426 exit the housing 420 at spaced intervals along a face 427 housing 420 and are typically formed of thin sheets of metal, for example copper, and typically apply a sprung, transverse, force on the tracks and ground plane.

The housing 420 has an elongate slot 428 having an opening 429 through a surface 430 of the housing and is arranged to receive the connector, in use. The housing 420 has a first cavity 432 adjacent the opening 429 that opens onto one side of the slot 428. A second cavity 434 opens onto the same side of the slot 428 as the first cavity 432 but is longitudinally displaced therefrom along the slot 428. A third cavity 436 opens onto an opposite side of the slot 428 to the first and second cavities 432, 434 and partially faces the second cavity 434.

Each of the first plurality of signal contacts 422 comprises elongate an L-shaped body portion 438 and an open partially trapezium, or curved shaped head portion 440. Each body portion 430 has a foot 442, that extends over part of the face 427 so as to provide an external electrical contact, and an arm 444 that passes through a channel in the housing 402 into the first cavity 432.

A first section 445 of the head portion 440 rests upon an internal surface 446 of the first cavity 432 such that a second section 448 that is parallel to the first section 445, projects slightly into a space of the slot 428 and is resiliently deformable in a direction perpendicular thereto.

The ground plane connector 426 is formed in a similar manner to each of the first plurality of signal contacts 422 but extends for substantially all of the width of the ground plane 404 of the connector 400. The ground plane connector 426 is also mounted within the housing 420 and passes into the second cavity 434 in a similar manner to each of the first plurality of signal contacts 422. The ground plane connector 426 may be continuous, as shown in FIG. 4A, or it may be formed of a plurality of fingers 450, as shown in FIG. 4B. It will be appreciated that the provision of a number of points of contact to the ground plane is advantageous as an increased number of contact points yields an increased surface area of contract through which return currents can be channelled. This reduces inductance, hence RFI and EMC are reduced. To this end it may be that the head portion of the ground plane connector may be roughened, stippled, undulate or have projections therefrom, as shown in FIGS. 4C to 4F. As will be appreciated if a pair of generally flat surfaces are in face to face contact there can be a local high spot on one of them which in effect presents true electrical contact across their flat faces, and instead achieves only point contact. Thus the actual contact cross-sectional area could be low. It is preferred deliberately to have many points of contact, so that the sum total of areas of points of contact is guaranteed to be acceptable.

The second plurality of signal contacts 424 have an elongate L-shaped body 452 and an inverted open partially trapezium shaped or curved head 454. The L-Shaped body 452 is longer than that of the first plurality of signal contacts in order that the head 454 can reside in the third cavity 436. A first section 456 of the head 454 engages a wall of the cavity 436 such that a second section 457 of the head 454 projects slightly into the slot 428 and is resiliently deformable therefrom in a direction perpendicular thereto.

In use, the connector 402 is inserted through the opening 429 into the slot 428. The ground plane 404 and the second plurality of signal tracks 408 pass over the first plurality of signal contacts 422 without contacting them. The ground plane 404 engages the ground plane connector 426 deflecting it out of the slot 428 and forming an electrical connection therewith. The ground plane connector 426 typically extends over substantially all of the width of the ground plane 404. It will be appreciated that a single extended, flat ground plane contact whilst nominally yielding a large contact area will in fact not do so, as only a single point of contact may be established between the contact and the ground plane. The roughening, for example the introduction of minute grooves thereupon (possible tens of grooves, or hundreds, or more), of the contact increases the possible number of contact points.

The longitudinal spacing of the contact regions 414, 416 of the first and second pluralities of signal tracks 404, 406 is such that it matches the longitudinal spacing of the second sections 448, 457 of the respective heads 440, 454 of each of the respective first and second pluralities of signal contacts 422, 424.

Upon insertion of the connector 402 into the slot 428 the first and second pluralities of signal tracks 406, 408 engage the contact elements 422 and 424, deflect them, and form electrical contacts with the respective first and second pluralities of signal contacts 422, 424 substantially simultaneously. This engagement results in connector 402 being held between the resiliently biased first plurality of signal contacts 422, the ground contact 426 and the resiliently biased second plurality of signal contacts 424.

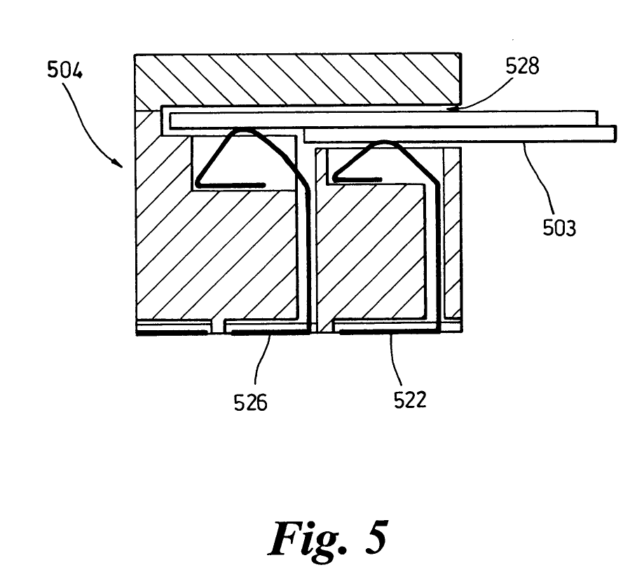

Referring now to FIG. 5, a connector receiver 504 is of a similar form to that of FIG. 4 and similar parts are accorded the same reference numerals in the five hundred series. The receiver 504 is arranged to receive a single sided connector 503 and is constructed in a similar fashion to that of FIG. 4. However, the slot 528 is shorter than that of FIG. 4 and there are only provided a ground plane connector 526 and a first plurality of signal contacts 522. Additionally there is no cavity corresponding to the third cavity 436 in the connector receiver 504.

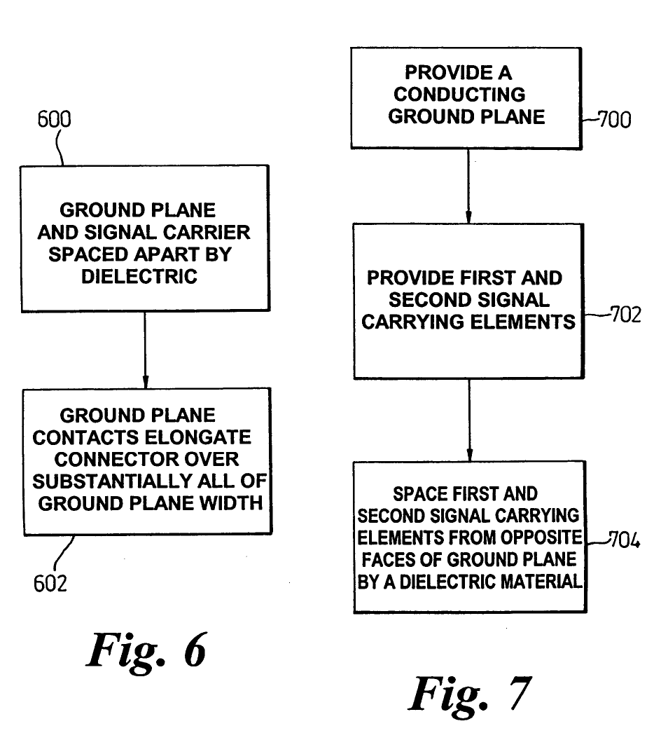

Referring now to FIG. 6, a method of reducing inductance in an electrical connection for carrying high frequency signals, including a flexible electrical connector comprises, providing a ground plane and a signal carrier spaced apart by a insulator (Step 600). The ground plane contacts an elongate connector over substantially all of the width of the ground plane so as to provide an extended contact region therebetween (Step 602).

Referring now to FIG. 7, a method of increasing signal carrying capacity of a flexible electrical connector comprises providing a conducting ground plane (700). First and second signal carrying elements, typically metal tracks, are provided (Step 702) and are spaced from opposite surfaces of the ground plane by a insulator material (Step 704).

Referring now to FIG. 8, a connector 800 comprises a ground plane 802 and first and second signal tracks 804, 806. The tracks 804, 806 are spaced apart from opposite faces of the ground plane by an insulator 808. A terminal end region 810 of the ground plane and respective terminal end regions 812, 814 of the first and second signal tracks are exposed so as to define contact regions. The end region 810 extends longitudinally beyond the end region 812 and the end region 814 extends longitudinally beyond the end region 810 such that all of the exposed surface of the end regions 810, 812, 814 are facing in the same in the same direction and are staggered.

Referring now to FIG. 9, a connector 900 comprises a ground plane 902 and first and second signal tracks 904, 906. The tracks 904, 906 are spaced apart from opposite faces of the ground plane by an insulator 908. A terminal end region 910 of the ground plane and respective terminal end regions 912, 914 of the first and second signal tracks 904,906 are exposed so as to define contact regions. The end region 910 extends longitudinally beyond the end region 912 and the end region 914 is located at substantially the same longitudinal position as the end region 912. Thus, the exposed end region 910 of the ground plane 902 is staggered with respect to the respective end regions 912, 914 of the first and second tracks 904, 906 which are not staggered with respect to one another.

What is claimed is:

1. A flexible electrical connector adapted to connect to a complimentary electrical connector receiver, said flexible electrical connector comprising first and second pluralities of spaced apart, elongate, signal carriers; an elongate current return conductor; and an insulator; said first plurality of signal carriers being spaced apart from said current return conductor by said insulator and extending substantially parallel to said current return conductor, and said second plurality of signal carriers being spaced from an opposite side of said current return conductor to said first plurality of signal carriers by a further insulator, respective exposed end regions of said first and second pluralities of signal carriers and said current return conductor comprising respective, integrally formed contact regions thereof, said contact regions being adapted to couple said first and second pluralities of signal carriers and said current return conductor electrically to corresponding contacts of said complimentary electrical connector receiver.

2. A connector according to claim 1 wherein said first and second pluralities of signal carriers are thin film tracks deposited upon said insulators.

3. A connector according to claim 1 wherein one of (i) said plurality of signal carriers and (ii) said current return conductor, extends longitudinally of the other of (i) and (ii) beyond a terminal end of said other of (i) and (ii) so that end portions of (i) and (ii) are staggered in position longitudinally along said connector.

4. A connector according to claim 1 wherein said second plurality of signal carriers extend longitudinally of said connector beyond a terminal end of said first plurality of signal carriers.

5. A connector according to claim 1 wherein said second plurality of signal carriers extend longitudinally of said connector beyond a terminal and of said current return conductor.

6. A connector according to claim 4 wherein said second plurality of signal carriers extend longitudinally of said connector beyond a terminal end of said current return conductor.

7. A connector according to claim 1 wherein said current return conductor is at least as wide as a total width spanned by a wider one of the following: said first plurality of signal carriers, said second plurality of signal carriers.

8. A connector according to claim 1 wherein a terminal end of said second plurality of signal carriers is located at substantially the same longitudinal location as a terminal end of one of the following: said first plurality of signal carriers, said current return conductor.

9. A connector according to claim 1 wherein said connector has a positive location formation disposed at one of the following: an edge of the connector, a side portion of the connector.

10. A connector according to claim 1 wherein the current return conductor is one of the following: a sheet of conducting material, a mesh of a conducting material.

11. A connection arrangement comprising a flexible connector comprising a flexible electrical connector adapted to connect to a complimentary electrical connector receiver, said flexible electrical connector comprising first and second pluralities of spaced apart, elongate, signal carriers; an elongate current return conductor; and an insulator; said first plurality of signal carriers being spaced apart from said current return conductor by said insulator and extending substantially parallel to said current return conductor, and said second plurality of signal carriers being spaced from an opposite side of said current return conductor to said first plurality of signal carriers by a further insulator, respective exposed end regions of said first and second pluralities of signal carriers and said current return conductor comprising respective, integrally formed contact regions thereof, said contact regions being adapted to couple said signal carriers and said current return conductor electrically to corresponding contacts of said complimentary electrical connector receiver and a complimentary electrical connector receiver comprising a housing, first and second pluralities of signal contacts, and a current return conductor contact: each of said first and second pluralities of signal contacts being arranged to engage said respective contact regions of said first and second pluralities of signal carriers, each of said first plurality of signal contacts being configured so as to allow said connector to pass thereover so as to enable said current return conductor to contact said current return conductor contact.

12. An arrangement according to claim 11 wherein said current return conductor contact is arranged to contact said current return conductor contact region over a substantial fraction of said current return conductor's width, in use, when said first plurality of signal carrier contact regions are in contact with said plurality of signal contacts.

13. An arrangement according to claim 11 wherein there is a single elongate contact for contacting said current return conductor to ground.

14. An arrangement according to claim 11 wherein said first plurality of signal contacts and said current return conductor contact are arranged to be biased against a surface of said connector, in use.

15. An arrangement according to claim 11 wherein said first plurality of signal contacts are arranged to be biased against said connector at a first surface thereof and said second plurality of signal contacts are arranged to be biased against said connector at a second surface thereof so as to retain positively, in use, said connector.

16. An arrangement according to claim 11 wherein said housing comprises a fixing arranged to co-operate with a positive location formation upon said connector, in use.

17. An arrangement according to claim 11 wherein said current return conductor contact is roughened, rippled, bent or dimpled, or has projections thereupon.

18. A connector receiver for receiving a flexible connector, comprising a housing, a current return conductor contact, and first and second signal contacts, said current return conductor contact being arranged to contact a current return conductor of said flexible connector over a substantial fraction of said current return conductor's width, and said first signal contact being arranged to contact a signal carrier of said flexible connector, and said second signal contact being arranged to contact at least one further signal carrier, said further signal carrier being disposed upon an opposite face of said flexible connector from said signal carrier.

19. A receiver according to claim 18 wherein said current return conductor contact and said signal contact are spaced apart longitudinally with respect to the direction of insertion of the flexible connector into said receiver.

20. A receiver according to claim 18 wherein said current return conductor contact is one of the following: roughened, rippled, bent, dimpled, has projections thereupon.

21. A flexible electrical connector adapted to connect to a complimentary electrical connector receiver, said flexible electrical connector comprising first and second pluralities of spaced apart, elongate, thin film metal tracks, each of which is arranged to carry a signal; an elongate metal ground plane; and an insulating layer; said first plurality of metal tracks being spaced apart from said ground plane by said insulating layer and extending substantially parallel to said ground plane, and said second plurality of metal tracks being spaced from an opposite side of said ground plane to said first plurality of metal tracks by an, or the, insulating layer, respective exposed end regions of said first and second pluralities of metal tracks and said ground plane comprising respective, integrally formed contact regions thereof, said contact regions being adapted to couple said first and second pluralities of metal tracks and said ground plane electrically to corresponding contacts of said complimentary electrical connector receiver.

22. A connection arrangement comprising a flexible connector comprising a flexible electrical connector adapted to connect to a complimentary electrical connector receiver, said flexible electrical connector comprising first and second pluralities of spaced apart, elongate, thin film metal tracks, each of which is arranged to carry a signal; an elongate metal ground plane; and an insulating layer; said first plurality of metal tracks being spaced apart from said ground plane by said insulating layer and extending substantially parallel to said ground plane, and said second plurality of metal tracks being spaced from an opposite side of said ground plane to said first plurality of metal tracks by an, or the, insulating layer, respective exposed end regions of said first and second pluralities of metal tracks and said ground plane comprising respective, integrally formed contact regions thereof, said contact regions being adapted to couple said first and second pluralities of metal tracks and said ground plane electrically to corresponding contacts of said complimentary electrical connector receiver and a complimentary electrical connector receiver comprising a housing, first and second pluralities of signal contacts, and a ground plane contact: each of said first and second pluralities of signal contacts being arranged to engage said respective contact regions of said first and second pluralities metal tracks, each of said first plurality of signal contacts being configured so as to allow said connector to pass thereover so as to enable said ground plane to contact said ground plane contact.

23. A connector receiver for receiving a flexible connector, comprising a housing, a ground plane contact, and first and second signal contacts, said ground plane contact being arranged to contact a metal ground plane of said flexible connector over a substantial fraction of said ground plane's width, and said first signal contact being arranged to contact a first metal track, arranged to carry a signal, of said flexible connector, and said second signal contact being arranged to contact a second metal track, arranged to carry a signal, of said flexible connector, said second metal track being disposed upon an opposite face of said flexible connector from said signal carrier.
